(19) United States
(12) Patent Application Publication
(10) Pub. No.: US 2010/0118654 A1
(43) Pub. Date: May 13, 2010

(54) Vertical seismic profiling migration method

(76) Inventors: Ruiqing He, Brea, CA (US); Martin Karrenbach, Brea, CA (US)

Correspondence Address: Gregory IPL, P.C., 601 W. Main Avenue, Suite 904, SPOKANE, WA, 99201-3825, US

(21) Appl. No.: 12/291,360

(22) Filed: Nov. 8, 2008

(51) Int. Cl. G01V 1/00

(52) U.S. Cl. 367/57

(57) ABSTRACT

A method includes seismic wave field continuation, imaging and data analysis steps that are applied in a near well region.

### BACKGROUND

Vertical seismic profiling (VSP) is a seismic data acquisition, processing, and imaging method used to provide high resolution imaging of a region of a subterranean formation, and is typically used to image petroleum reservoirs. VSP differs from surface seismic imaging in that during VSP data collection one of the source or the receiver (typically, the receiver) is placed in a borehole in the formation, rather than having the source and receiver both located at the surface. Commonly, a string of geophones or other sensing devices, which act collectively as the receiver, are placed within a borehole during VSP data acquisition. The source can be located at the surface, or in another borehole (in which case the imaging is known as cross-well VSP, also known as cross-well tomography). In the case of an offshore (subsea) reservoir, the source is commonly an air gun placed in the water at or near the surface of the water.

The receiver or receivers in the borehole receive seismic energy produced by the source. The seismic energy arrives at the source both as upgoing waves and as downgoing waves. The receiver converts the detected energy into signals which are then transmitted to a data collection location. The signals are typically converted from analog signals to digital signals. The set of digital signals form a vertical seismic profile (VSP) data set representative of a region of the formation. This unprocessed VSP data can then be processed using known processing techniques to produce a model of the region, which can be stored on computer readable medium as VSP image data. The VSP image data can be used to generate visual images of the region, and can also be used for computer simulations and the like. Frequently VSP data is augmented with data from a surface seismic survey to produce a higher quality image of a portion of the formation. The seismic image is generated as a result of interaction (reflections, mostly) between the seismic energy from the source and events and structures within the subterranean formation, as well as traveltime of the signals from the source to the receiver (directly or indirectly). An example of a subterranean structure is a geological feature such as a dip, a fold, or a transition from one rock type to another (e.g., from sandstone to granite). A subterranean event can include not only geological features, but also a change in physical properties (e.g., density, porosity, etc.) within the same rock strata. Traveltime is also affected by changes in physical properties within the formation, typically as a function of depth.

Generally, traveltime is the time lapse between the generation of a seismic signal and the time at which a seismic receiver receives the signal. As can be appreciated, the density of a geologic formation through which a seismic signal travels has a significant impact on traveltime. A seismic signal will travel faster through a dense formation that it will through a less dense formation. It is therefore very desirable to know the density of a formation through which a seismic signal will travel in order that received signals can accurately indicate the total distance traveled by the signal prior to being received at a receiver. That is, since the essential objective of reflection seismology is to determine the location (depth) of events in a target area, it is important to have a reasonable approximation or model of the velocities of the different strata involved in the seismic survey. Complicating this process of developing the velocity model is the fact that a geologic formation through which a seismic single may travel (prior to being received at a receiver) is often not a single layer of a homogeneous material. Rather, the geologic formation typically consists of multiple layers each having different physical properties (typically density) which affect the rate at which a seismic signal propagates through the different layers.

In the case of vertical seismic profiling, it is somewhat relatively straight-forward to determine the velocities of different geologic layers within the zone of the receiver array. This can be done using a zero-offset source near the wellhead of the wellbore. However, geologic formations are typically imaged using an offset source in order to image features (geologic events such as rock layers, dips, folds, etc.) away from the wellbore. In this case, the portion of the geologic formation through with the seismic energy from the seismic source travels prior to reaching an event (known as the overburden) can vary as a function of offset distance, thus making it difficult to render a true image of the area of interest.

After performing a seismic survey, the seismic data is typically migrated to account for features in the subterranean formation which distort the image in the unprocessed data. Migration most commonly is used to move apparent dips and other features to a position closer to their true position when the data is rendered to an image. However, the overburden can have a significant effect on the collected data, and since specific overburden velocity information may be inaccurate or unavailable, migration cannot be successfully performed to render a representative image of the area of interest.

Therefore, what is needed is a way to perform seismic data migration, and particularly VSP data migration, velocity analysis, and inversion for rock related properties, which addresses the issue of overburden between the seismic source and the imaged area.

### BRIEF DESCRIPTION OF THE DRAWINGS

FIG. 1 is a schematic diagram depicting a vertical cross section of a subterranean formation and VSP data collection methods.

FIG. 2 is a schematic diagram depicting a vertical cross section of a subterranean formation and a first application of a method of the present invention including transmitted waves and reflected waves.

FIG. 3 is a schematic diagram depicting a vertical cross section of a subterranean formation and a second application of the method of the present invention including reflected shear and compression waves.

FIG. 4 is a schematic diagram depicting a vertical cross section of a subterranean formation and a third application of the method of the present invention including transmitted waves and reflected waves when more than one wellbore is used.

FIG. 5 is a diagram depicting a vertical cross section of a subterranean formation and an application of the method of the present invention wherein the migration is preformed using reverse time migration.

FIG. 6 is a diagram depicting a vertical cross section of a subterranean formation and an application of the method of the present invention wherein the migration is preformed using wavefield equation migration.

FIG. 7 is a diagram depicting a vertical cross section of a subterranean formation and an application of the method of the present invention wherein the migration is preformed using Kirchhoff migration.

FIG. 8 is a diagram showing an application of the method of the present invention to image the flank of a salt dome.

FIG. 9 is a diagram showing another application of the method of the present invention to image a generally horizontal reflector.

FIGS. 10A-10D together represent flowcharts representative of steps for carrying out the method of the present invention.

### Detailed Description

The methods described herein allow an improved velocity analysis, reflectivity inversion and migration technique that is particularly useful in imaging vertical seismic profile (VSP) data velocity in a region near a receiver array used to collect the VSP data.

The methods described herein can be performed using computers and data processors. The data described herein can be stored on computer-readable media. Furthermore, the methods described herein can be reduced to a set of computer readable instructions capable of being executed by one or more computer processors, and which can be stored on computer readable media.

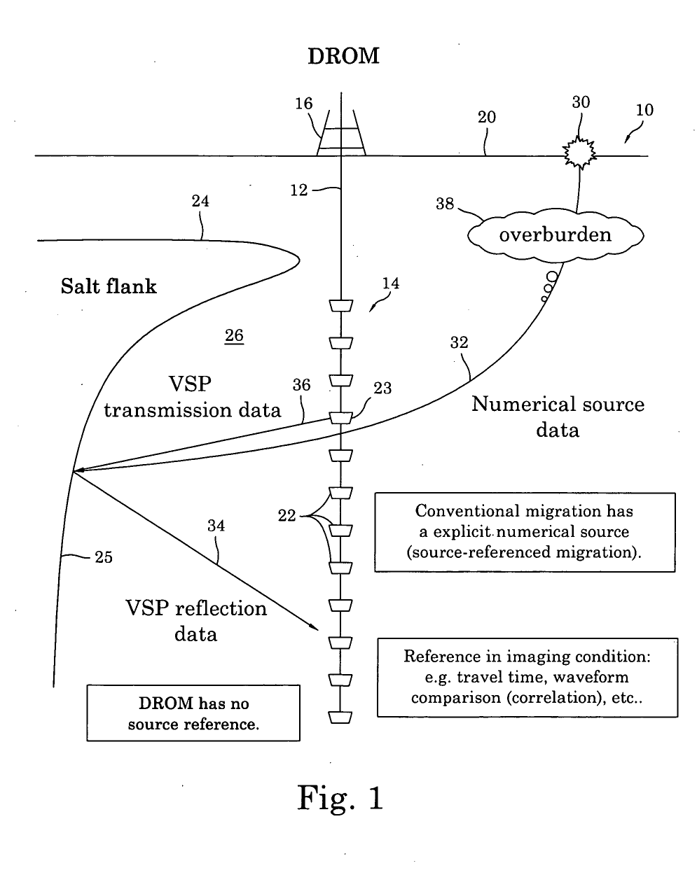

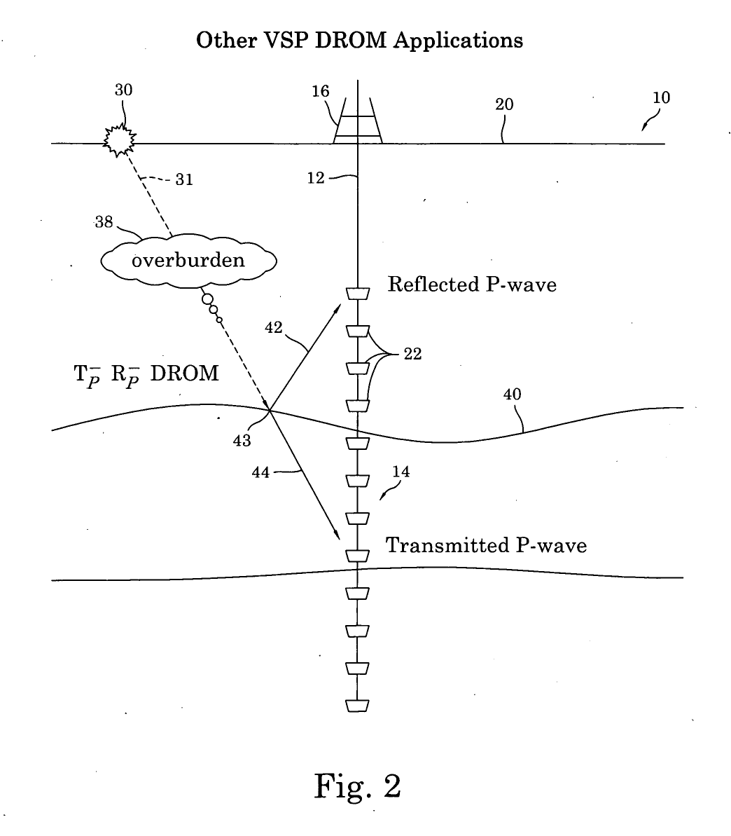

Turning now to FIG. 1, a schematic diagram depicting a vertical cross section of a subterranean formation 10 and VSP data collection methods is shown. In FIGS. 1-7 the common nomenclature will be used, although it will be appreciated that from figure to figure there may be variations in the specific locations and features of the referenced items. For example, reference numeral 10 is commonly used in FIGS. 1-7 to refer to a subterranean formation, although the specific features of the subterranean formation may vary from figure to figure. Any relevant variances in the subterranean formation 10 from one figure to another will be specifically called out in the discussion of the particular figure. Likewise, surface seismic source 30 is present in most of FIGS. 1-7, although the location of the surface seismic source with respect to the wellbore 12 may change from figure to figure. In addition to the subterranean formation 10, the wellbore 12, and the surface seismic source 30, FIGS. 1-7 also depict the following common items. Wellbore 12 is located at a wellhead 16, which is in turn located at an upper surface 20 of the subterranean formation 10. A receiver array 14 is depicted as being placed within the wellbore 12, and the receiver array comprises a plurality of spaced-apart geophones 22 (only two of which are typically identified in each figure). An overburden 38 is located within the subterranean formation 10, and intersects seismic energy passing from the surface source 30 to the geophones 22 of the receiver array 14. Further in the discussion of FIGS. 1-7, it will be appreciated that a seismic signal reaching the geophones 22 of the receiver array 14 includes information relevant to both shear waves (S-waves, identified by a subscript “s”), and compression waves (P-waves, identified by a subscript “p”). Further, in FIGS. 1-7 energy from the surface seismic source 30 includes energy transmitted directly to a geophone 22 as a downgoing wave (identified by the letter “T”), as well as energy reflected off of a subsurface event (e.g., reflector 40 of FIG. 2), which will be identified by the letter “P”. It will be appreciated that each transmitted wave “T”, as well as each reflected wave “R”, contains both shear (S) and compression (P) wave information. It will be further appreciated that shear and compression waves from a common source or reflection point travel at different velocities in the subterranean formation 120, and thus exhibit different angles of reflection and refraction as a result. Further, both transmitted waves and reflected waves exhibit each are characterized by positive or negative direction of extrapolation (indicated in the nomenclature in the figures, e.g., T⁻ₚ and R⁻ₚ in FIG. 2, representing backward extrapolated transmitted and reflected compression waves).

In FIG. 1 the subterranean formation 10 includes a salt dome 24, which is characterized and defined by a flank 25. The region 26 beneath the salt dome 24 (and bounded by the flank 25) is an area of interest for hydrocarbon exploration, since the salt dome 24 forms a natural trap for hydrocarbons in the area 26. It is therefore desirable to obtain an image of the region 26 in order to determine if it may potentially contain hydrocarbon reserves. However, salt domes are essentially barriers to the transmission of seismic energy (for purposes of seismic imaging), and therefore the surface seismic source 30 is typically offset from the salt dome 24 in order to allow seismic energy from the source to be transmitted into the region 26, as depicted in FIG. 1. As a consequence, seismic energy 32 from the source 30 must first pass through an overburden 38 prior to reaching the target area 26, and the seismic energy reflected from the salt flank 25 to the receiver array 14 will thus include any distortions imputed by the overburden 38. Since the characteristics of the overburden 38 are typically not well known (specifically, velocity information and any refractions in the overburden), it is not possible to correct data received at the receiver array 14 to account for these characteristics of the overburden. Consequently, when migrating the VSP data from such a survey, the unknown effects of the overburden 38 cannot be accounted for.

One method to address (and thus reduce) the effects of the overburden 38 in the situation of FIG. 1 (i.e., in imaging under a salt dome 24) is to replace the physical source 30 with a numerical (i.e., synthetic) source at the surface 20. Then, using ray tracing and wave propagation techniques, and data from the initial VSP survey using the physical source 30, the position of the reflected wave 34 can be corrected. However, this method suffers from the fact that the effects of the overburden 38 are still present when processing the numerical source data.

An improvement on this method is to replace the physical source 30 at the surface 20 with a numerical (i.e., synthetic) source at a receiver 23 through which the seismic energy from the physical source 30 passes. The result is synthetic wave 36. The reflection information 34 can then be migrated by correlating stacking of the VSP traces, which are known from the VSP survey using the surface seismic source 30. Preferably, this is done for each geophone 22 in the receiver array 14. The end result is a new wave field representative of the area between the salt flank 25 and the receiver array, which does not include irregularities introduced by the overburden 38. This new velocity model can then be used to migrate the salt flank 25 to a more representative image when rendering for visualization. As can be seen, in essence this results in rotating the image of FIG. 1 ninety degrees counter clockwise, such that the receiver array 14 acts as a horizontal surface having synthetic sources at each geophone 22, and the salt flank 25 runs in a more horizontal direction (i.e., closer to parallel to the receiver array 14), versus running in the more vertical direction actually present in the subterranean formation 10.

As can be seen, this method works reasonably well for migrating VSP data when the reflecting event (e.g., the flank 25 of the salt dome 24) is somewhat parallel to the wellbore 12 containing the receiver array (i.e., the event lies within about a 45 degree angle of parallel to the wellbore 12). However, for events which are more nearly orthogonal to the wellbore 12 (i.e., events which are closer to parallel to the surface 20), the method does not produce the same beneficial results.

Turning now to FIG. 2, a schematic diagram depicts a vertical cross section of a subterranean formation 10 and a first application of a method of the present invention which includes using transmitted waves and reflected waves in order to improve the migration of VSP data near the wellbore 12. More specifically, the surface seismic source 30 generates seismic energy 31 which passes through the overburden 38, and is then reflected at event 40 (resulting in reflected compression wave 42 received by the receiver array 14), and is also partially transmitted to the receiver array via transmitted compression wave 44. As can be seen, event 40 is more nearly orthogonal to wellbore 12 than is the salt flank 25 of FIG. 1. In this instance, the method of the present invention can be used to more accurately migrate data from the reflection point 43 near the wellbore 12. In this case, the transmitted and reflected wavefields are both used to extrapolate backwards (into the formation 10, and away from the wellbore 12) the VSP data, which is correlated with the VSP survey data using the surface source 30.

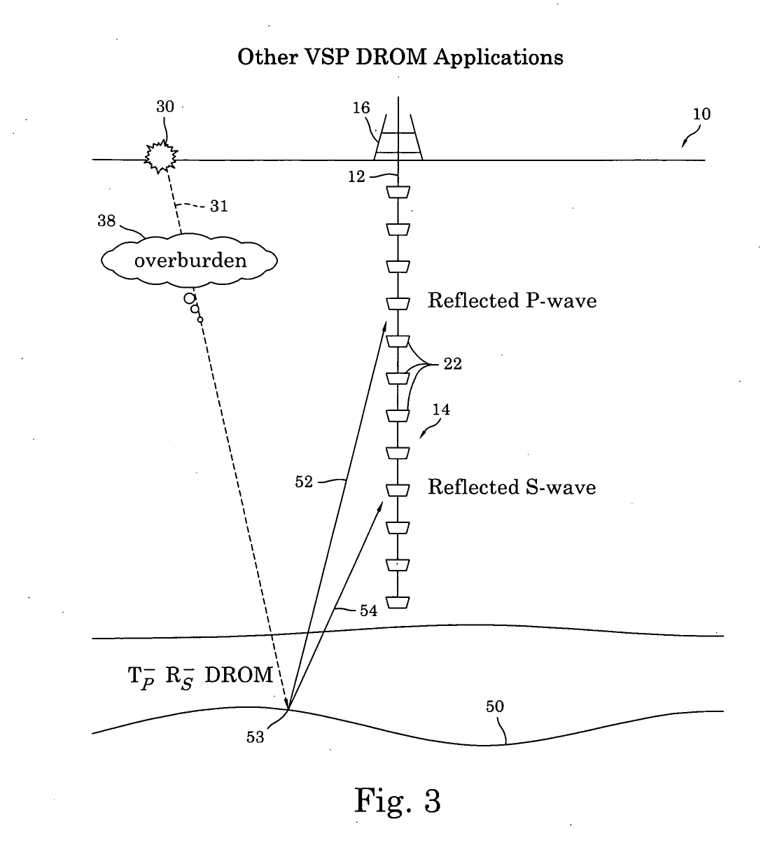

Turning now to FIG. 3, a schematic diagram depicts a vertical cross section of a subterranean formation 10 and a second application of a method of the present invention which includes using reflected shear and compression waves in order to improve the migration of VSP data near the wellbore 12. More specifically, the surface seismic source 30 generates seismic energy 31 which passes through the overburden 38, and is then reflected at event 50, resulting in reflected compression wave 52 and reflected shear wave 54 which are received by different geophones 22 of the receiver array (due to the differences in velocity and other characteristics of shear waves and compression waves). Again, as can be seen, event 50 is more nearly orthogonal to wellbore 12 than is the salt flank 25 of FIG. 1. In this case, the two different reflected wavefields are used to extrapolate backwards (into the formation 10, and away from the wellbore 12) the VSP data, which is correlated with the VSP survey data using the surface source 30. In this instance, the method of the present invention can be used to more accurately migrate, further process, and analyze data from the reflection point 53 near the wellbore 12.

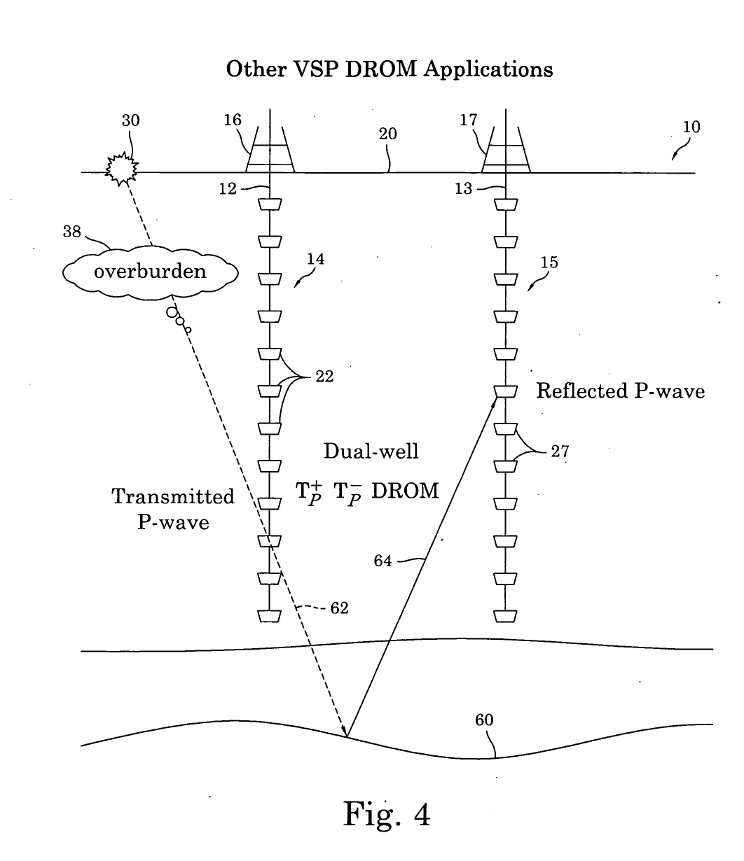

Turning now to FIG. 4, a schematic diagram depicts a vertical cross section of a subterranean formation 10 and a third application of the method of the present invention which includes using transmitted waves and reflected waves when more than one wellbore is used. In this case, a second wellbore 13 penetrates the subterranean formation at wellhead 17, and a second receiver array 15 having geophones 27 is placed into the wellbore. The surface seismic source 30 generates seismic energy 62 which passes through the overburden 38, and is then reflected at event 60, resulting in reflected compression wave 64. The directly transmitted P-wave 62 from the source 30 is received by receiver array 14, and reflected shear wave 54 is received by the receiver array 15. In this case, since the point of interest at event 60 lies between wellbores 12 and 13, the transmitted wave energy received at receiver array 14 can be extrapolated to the right, and the reflection energy received at receiver array 15 can be extrapolated to the left, thus providing for improved migration and thus imaging of the area between the wellbores. The extrapolation techniques used here are essentially similar to the techniques used in the other foregoing examples—i.e., wave field extrapolating the virtual source data from the geophones in each array back into the formation using data from the initial VSP survey. From FIG. 4 it will be appreciated that the method of the present invention can be used with a plurality of wellbores and receiver arrays in order to improve migration of VSP data in areas of interest in the formation 10.

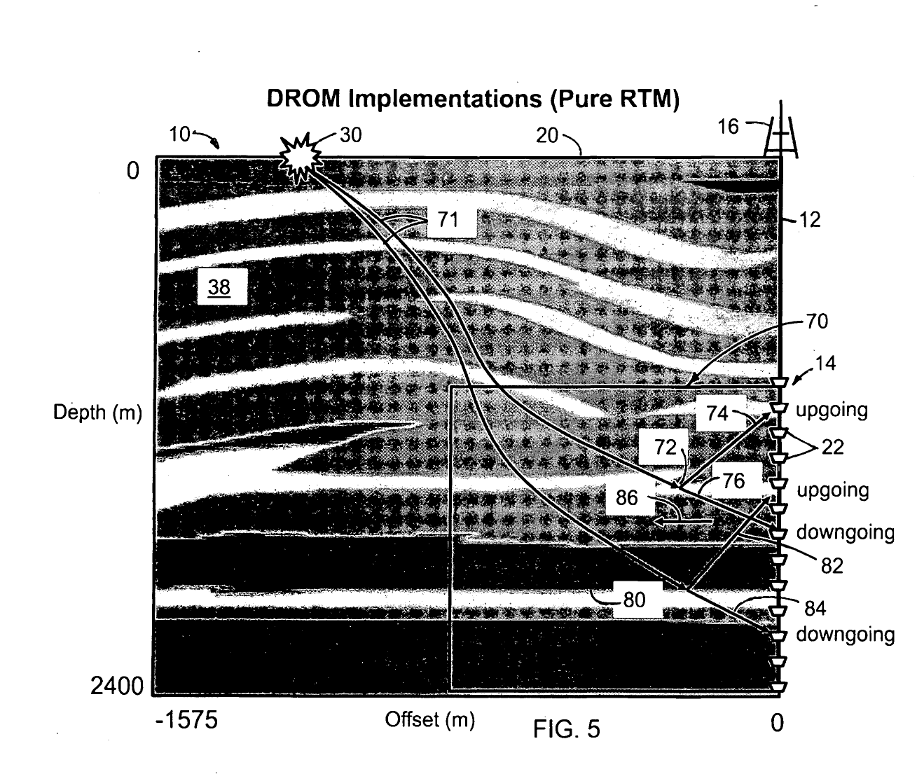

Various means can be used to extrapolate the correlated VSP data from the wellbore back into the formation in the near-wellbore region. Three examples are depicted in FIGS. 5-7. Turning to FIG. 5, a diagram depicts a vertical cross section of a subterranean formation 10 and an application of the method of the present invention wherein the migration is performed using reverse time migration in order to provide better imaging in the region of interest 70 near the wellbore 12. In this example, seismic energy 71 from surface source 30 passes through the overburden 38. Some of the seismic energy 71 is reflected off of reflectors 72 and 80, resulting in respective reflected (upgoing) waves 74 and 82, while other of the energy 71 passes through the reflectors as transmitted (downgoing) waves 76 and 84. The upgoing and downgoing wavefields are first separated. Reverse time migration (RTM) is then used as the means in the method to extrapolate each of the wavefields back into the region 70 in direction 86, beginning at the wellbore 12.

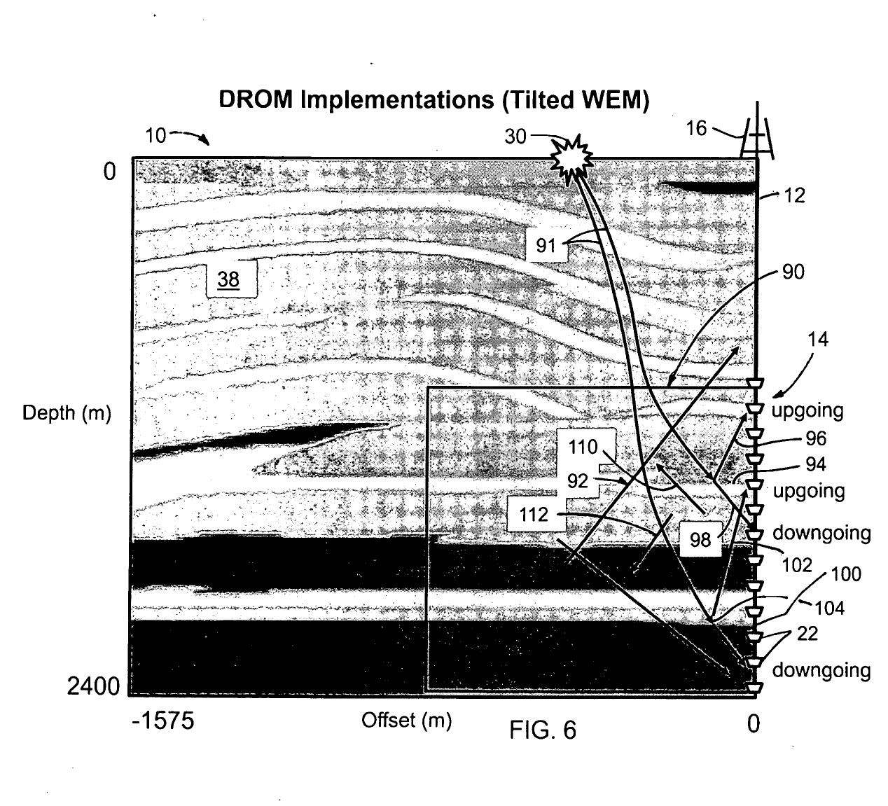

Turning to FIG. 6, a diagram depicts a vertical cross section of a subterranean formation 10 and an application of the method of the present invention wherein the migration is performed using wavefield equation migration (WEM) in order to provide better imaging in the region of interest 90 near the wellbore 12. In this example, seismic energy 91 from surface source 30 passes through the overburden 38. Some of the seismic energy 91 is reflected off of reflectors 94 and 100, resulting in respective reflected (upgoing) waves 96 and 102, while other of the energy 91 passes through the reflectors as transmitted (downgoing) waves 98 and 104. Again, the data is separated into the upgoing and downgoing wavefields, as well as into shear and compressive waves. A tilted coordinate system 92 is provided for the extrapolation and migration, and using wave equation migration both wave fields) are simultaneously extrapolated in directions 110 and 112, beginning at wellbore 12. As can be appreciated, the simultaneous extrapolation in the two generally orthogonal directions 110 and 112 provide an interferometric process whereby information from migration in one direction is used to modify information from migration in the other direction.

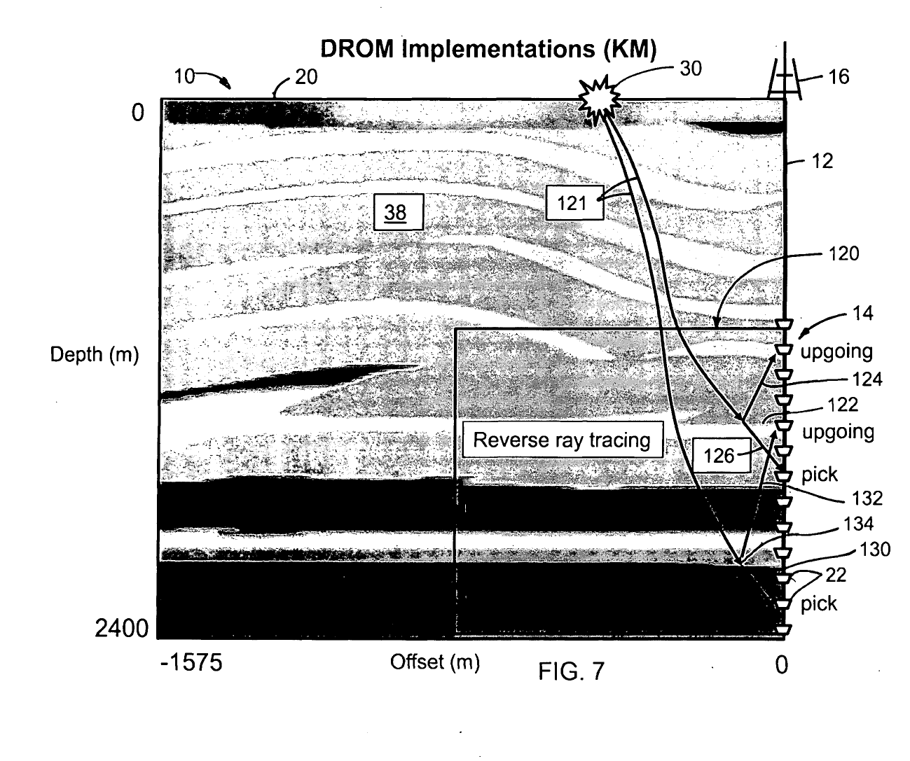

Turning to FIG. 7, a diagram depicts a vertical cross section of a subterranean formation 10 and an application of the method of the present invention wherein the migration is preformed using Kirchhoff migration in order to provide better imaging in the region of interest 120 near the wellbore 12. In this example, seismic energy 121 from surface source 30 passes through the overburden 38. Some of the seismic energy 121 is reflected off of reflectors 122 and 130, resulting in respective reflected (upgoing) waves 124 and 132, while other of the energy 121 passes through the reflectors as transmitted (downgoing) waves 126 and 134. Again, the data is separated into the upgoing and downgoing wavefields. In this application, the traveltimes are computed purely from picked traveltimes measured in the well 12. Then, using an iterative circular process, ray tracing is performed, the wave information is back-extrapolated into the region 120, and reverse ray tracing is then performed. As can be seen, in this case the process begins at the reflection points and progresses towards the wellbore 12. It will be appreciated that the migration method is performed locally in the region proximate the wellbore 12, rather than throughout the entire area of the region of interest 120.

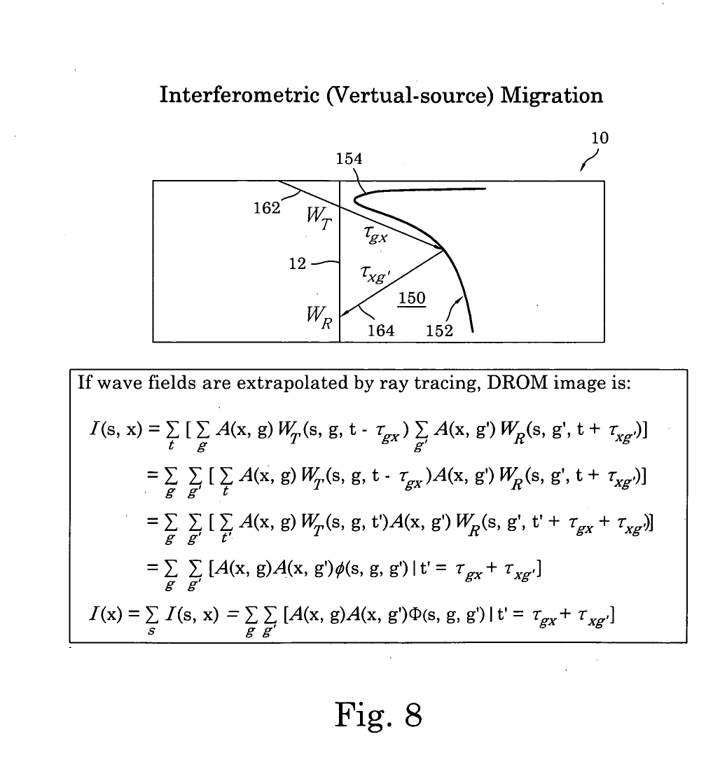

Turning to FIG. 8, a diagram depicts an application of the method of the present invention to image a flank 152 of a salt dome 154 within a geologic formation 10. In this example, interferometric (or virtual source) migration is used. The wavefields include the transmitted wavefield W_{T} and the reflected wavefield W_{R}.

If wave fields are extrapolated by ray tracing, DROM image is:

$$\begin{matrix}I ( s , x ) = {\sum }_{t} [ {\sum }_{g} A ( x , g ) {W}_{T} ( s , g , t - {τ}_{gx} ) \\ {\sum }_{{g}^{′}} A ( x , {g}^{′} ) {W}_{R} ( s , {g}^{′} , t + {τ}_{{xg}^{′}} ) ] \\ = {\sum }_{g} {\sum }_{{g}^{′}} [ {\sum }_{t} A ( x , g ) {W}_{T} ( s , g , t - {τ}_{gx} ) \\ A ( x , {g}^{′} ) {W}_{R} ( s , {g}^{′} , t + {τ}_{{xg}^{′}} ) ] \\ = {\sum }_{g} {\sum }_{{g}^{′}} [ {\sum }_{{t}^{′}} A ( x , g ) {W}_{T} ( s , g , {t}^{′} ) A ( x , {g}^{′} ) \\ {W}_{R} ( s , {g}^{′} , {t}^{′} + {τ}_{gx} + {τ}_{{xg}^{′}} ) ] \\ = {\sum }_{g} {\sum }_{{g}^{′}} [ A ( x , g ) A ( x , {g}^{′} ) Ø ( s , g , {g}^{′} ) \vert {t}^{′} = {τ}_{gx} + {τ}_{{xg}^{′}} ]\end{matrix}$$

$$I ( x ) = {\sum }_{s} I ( s , x ) = {\sum }_{g} {\sum }_{{g}^{′}} [ A ( x , g ) A ( x , {g}^{′} ) Φ ( s , g , {g}^{′} ) \vert {t}^{′} = {τ}_{gx} + {τ}_{{xg}^{′}} ]$$

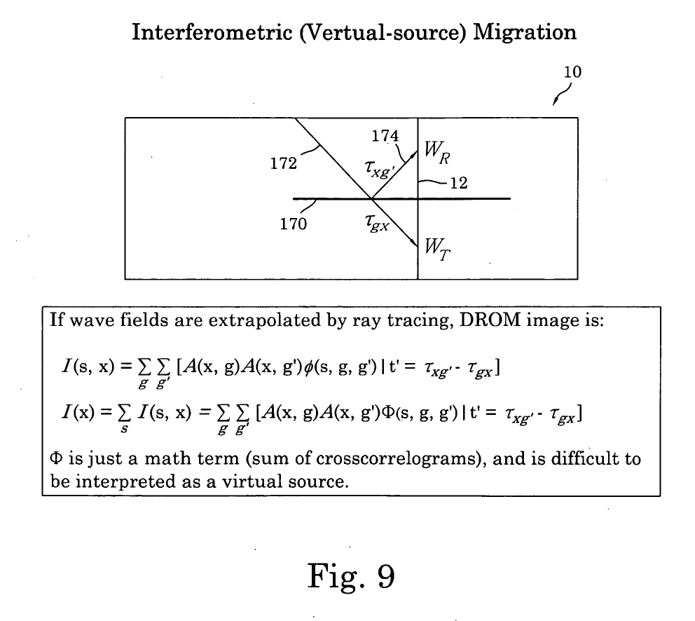

Turning now to FIG. 9, a diagram showing another application of the method of the present invention to image a generally horizontal reflector 170 in a subterranean formation 10. In this example, as with FIG. 8, interferometric (or virtual source) migration is used. The wavefields include the transmitted wavefield W_{T} and the reflected wavefield W_{R}. By comparison with the example in FIG. 8, in FIG. 9 the transmitted and reflected waves in FIG. 9 will include information from reflector 170, whereas in FIG. 8 the transmitted wavefield will not include such information. Further, the orientation of the transmitted waves will be opposite from those in FIG. 8.

In wavefields that are extrapolated by ray tracing, DROM image is

$$I ( s , x ) = {\sum }_{g} {\sum }_{{g}^{′}} [ A ( x , g ) A ( x , {g}^{′} ) Ø ( s , g , {g}^{′} ) \vert {t}^{′} = {τ}_{{xg}^{′}} - {τ}_{gx} ]$$

$$I ( x ) = {\sum }_{s} I ( s , x ) = {\sum }_{g} {\sum }_{{g}^{′}} [ A ( x , g ) A ( x , {g}^{′} ) Φ ( s , g , {g}^{′} ) \vert {t}^{′} = {τ}_{gx} + {τ}_{{xg}^{′}} ]$$

φ is just a math term (sum of crosscorrelograms), and is difficult to be interpreted as a virtual source.

Having wave fields that are extrapolated in the above described manner and made available for further analysis allows a high-resolution velocity analysis to be performed close to, yet an appreciable far distance away from, the receiver array 14 or well bore 12.

In particular the method uses a hybrid imaging condition, where the wave fields are extrapolated using suitable wave equation continuation methods, and instead of a correlation imaging condition, an extrapolated travel time is used to provide an imaging reference time. Such computed reference time is based purely on travel time information that has been picked (automatically or manually) from the seismic data itself, and is thus not reliant on the overburden. Thus provides a novel way for high-resolution velocity analysis in the region of the back extrapolation.

High-resolution velocity analysis can be carried out in the angle gather domain (time or depth) or with coherence and semblance measures that estimate focusing and phase alignment of events. In the presented method however there is a choice of wave fields to be used for the analysis—transmitted, reflected P or S wave types can be used individually or combined to produce a data measure on velocity quality. This quality criterion guides the velocity model improvement process.

The region of the extrapolation is limited to a trusted region, where reflection angles and reflectivities are well behaved. Beyond this angle range and location range, image artifacts will be produced, which are recognizable. Thus, an automatic or manual image cut off can be applied for the imaging, as well as for high-resolution velocity analysis.

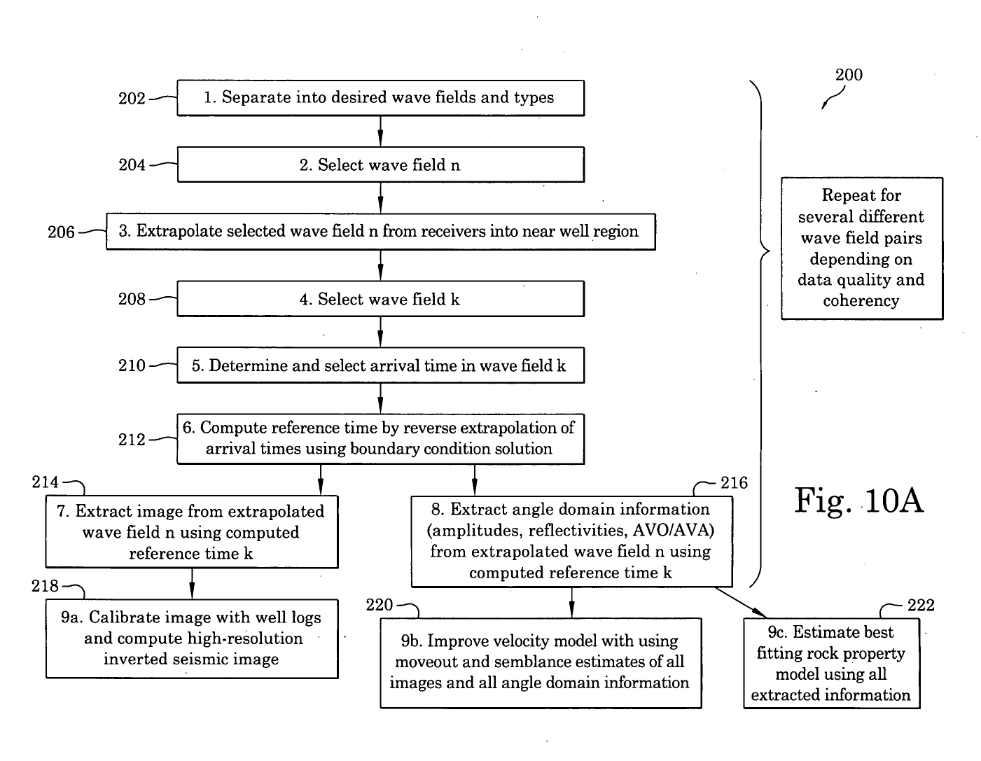

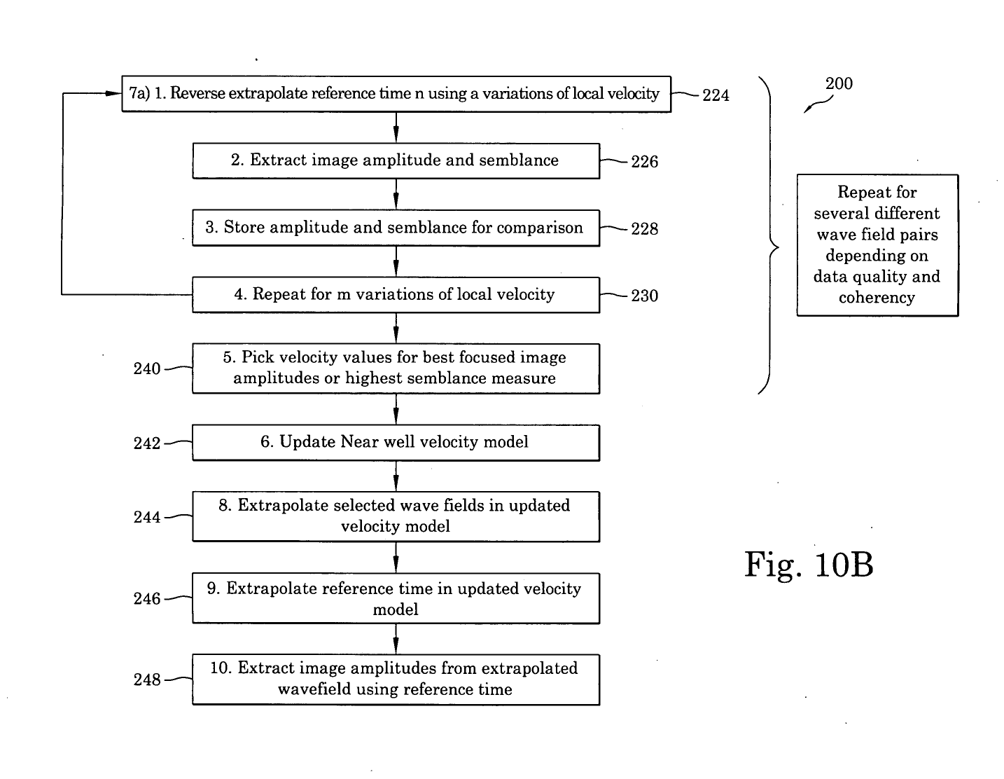

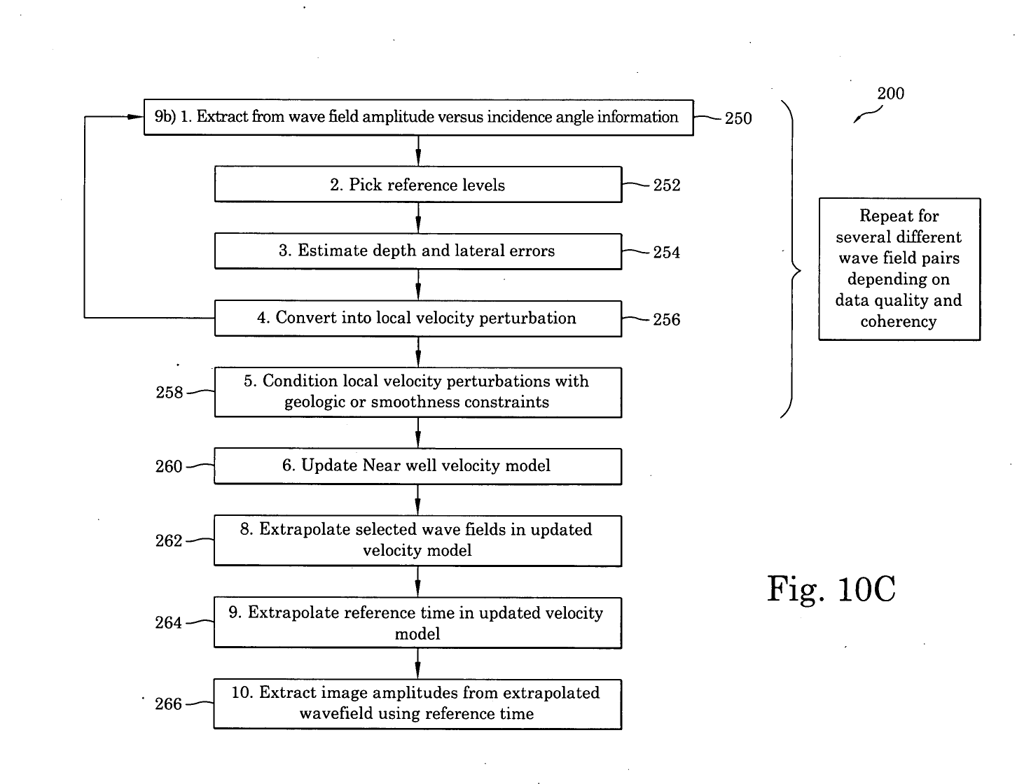

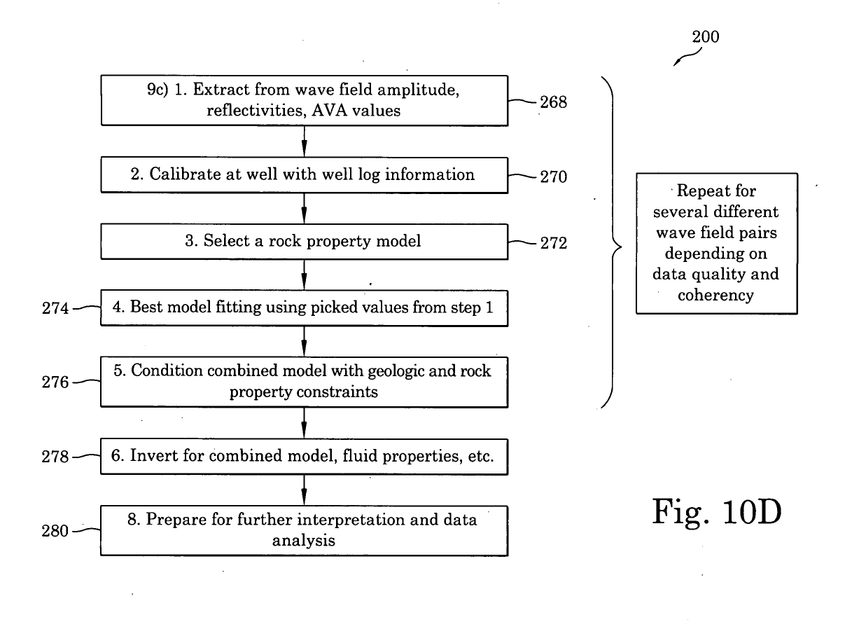

FIGS. 10A-10D together represent flowcharts representative of exemplary steps for carrying out the method of the present invention. In FIGS. 10A-10D, the exemplary steps are numbered in even numbers, beginning with step 202 (FIG. 10A) and ending with step 280 (FIG. 10D). The methodology of performing steps 202-280 is apparent in light of the above disclosure.

The method can use acoustic or elastic wave fields in the extrapolation process and thus simultaneously estimate p and s velocity models, and anisotropy parameters.

True-amplitude and reflectivities, AVO and AVO curves can be measured with high-resolution in those extrapolated and image highly coherent wave field data that are undisturbed by the overburden effects. These measurements can be tied in to well log information that has been usually measured in the well bore itself, thus providing a manner in which such local well information is reliably extrapolated into the near well region using the present method. Thus true-amplitude reflectivity and AVO/AVA curves can be calibrated to the well and produce more reliable estimates of subterranean properties the near well region.

Seismic wave field inversion into rock properties can be carried out in the trust region with high-resolution, and with little interfering noise.

Near well images and near well properties can directly augment conventional VSP imaging and data analysis in a region where usually extraction of such information is limited due to unfavorable primary reflection geometry.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims as appropriately interpreted.

We claim:

1. A method comprising:
seismic wave field continuation, imaging and data analysis steps that are applied in a near well region.

2. The method of claim 1 wherein
a. Wave fields are selected (p, s, transmitted, reflected) and selectively extrapolated using wave equation methods on optimized numerical grids

3. The method of claim 2 wherein wave fields are imaged using a backward extrapolated wave field and computed reference times computed by reverse extrapolating picked travel times in the seismic gathers, thus providing high-resolution images, angle gathers and other data attributes.

4. The method of claim 3 wherein the extrapolated or imaged seismic data are used to perform a high-resolution velocity analysis by means of one of angle gather analysis or stacking analysis using semblance or coherence measures of thus derived data attributes.

5. The method of claim 3 wherein the extrapolated or imaged seismic data are used to extract true-amplitude reflectivities in images within the near well trust region.

6. The method of claim 3 wherein extrapolated data or imaged wave field data are used to extract AVO/AVA curves to determine subterranean properties with high-resolution and with high confidence.

7. The method of claim 4 wherein well log data is used to calibrate the formed wave field and images with a near well trust region, enabling to project the highly detailed nature of the well log information out to an appreciable distance away from the well bore or receiver array.

8. The method of claim 4 wherein well log data and other information measured in the borehole and thus extrapolated and imaged wave fields are used to invert directly for rock properties and used to produce a high-resolution inverted seismic section for conventional interpretation.
